(19) United States
(12) Patent Application Publication
(10) Pub. No.: US 2014/0152100 A1
(43) Pub. Date: Jun. 5, 2014

(54) POWER STORAGE SYSTEM AND DRIVING METHOD THEREOF

(71) Applicant: SAMSUNG SDI CO., LTD., Yongin-si (KR)

(72) Inventor: Hyung-Hoon LIM, Yongin-si (KR)

(21) Appl. No.: 13/897,589

(22) Filed: May 20, 2013

(30) Foreign Application Priority Data
Dec. 5, 2012 (KR) 10-2012-0140502

(51) Int. Cl. H02J 9/00; H02J 7/00

(52) U.S. Cl. CPC H02J 9/00; H02J 7/00
USPC 307/23; 320/128; 307/18

(57) ABSTRACT

A power storage system includes a battery that stores power, a first switch connected between a first node and the battery, the first switch forming a path for charging the battery and including a body diode, and a first diode connected between terminals of the first switch and forming a path for discharging the battery.

### CROSS-REFERENCE TO RELATED APPLICATION

The present application claims priority under 35 U.S.C. §119 to Korean Patent Application No. 10-2012-0140502, filed on Dec. 5, 2012, in the Korean Intellectual Property Office, and entitled: “Power Storage System and Driving Method Thereof,” which is incorporated by reference herein in its entirety.

### BACKGROUND

1. Field

Embodiments relate to a power storage system and a driving method.

2. Description of the Related Art

With environment destruction, resource exhaustion, etc., being current issues, attention to systems storing power and efficiency of use of the stored power has increased.

A power storage system may store generated power of renewable energy in a battery, or may store the power of a common grid in the battery in cooperation with the common grid. The power storage system may supply the stored power to the common grid or a load.

### SUMMARY

Embodiments are directed to a power storage system including a battery that stores power, a first switch connected between a first node and the battery, the first switch forming a path for charging the battery and including a body diode, and a first diode connected between terminals of the first switch and forming a path for discharging the battery.

The power storage system may further include a second switch connected between the first switch and the battery and forming a path for charging and discharging the battery.

The first switch and the second switch may be in a turned-on state when the battery is in a state of being charged. The first switch may be in a turned-off state and the second switch may be in the turned-on state when the battery is in a state of being discharged.

The second switch may be in a turned-off state to protect the battery when a fault occurs in the battery.

The power storage system may further include a battery management system that manages the battery, the battery management system controlling the first switch and the second switch.

The power storage system may further include a DC-DC converter that converts a first voltage output from the battery into a second voltage, the second voltage being supplied as power for operating the battery management system.

The power storage system may further include an AC-DC converter that converts a voltage of a common grid into a third voltage, the third voltage being supplied as power for operating the battery management system.

The second voltage may be used as power for operating the battery management system when a power failure occurs in the common grid. The third voltage may be used as power for operating the battery management system when the common grid is operated normally.

The battery may include a first battery rack and a second battery rack respectively including a plurality of cells. The battery management system may include a first battery management system managing the first battery rack and a second battery management system managing the second battery rack.

A voltage output from the first battery rack and a voltage output from the second battery rack may be output to the first node. The power storage system may include a DC-DC converter that converts a first voltage of the first node into a second voltage. The second voltage may be used as power for operating the first battery management system and the second battery management system.

The power storage system may further include a first power converter that converts a first power into a second power and provides the second power to the first node, and a second power converter that converts the power of the first node into a third power and supplies the third power to a common grid or a load.

Embodiments are also directed to method driving a power storage system, including providing a battery storing power, converting a first power into a second power and providing the second power to a first node, charging the battery through a first current path by using the second power provided to the first node, and discharging the battery through a second current path, the second current path including a diode connected between the battery and the first node.

The charging of the battery may include turning on a first switch, the first switch being connected between the first node and the battery and including a body diode, to form the first current path.

The charging of the battery may include turning on a second switch, the second switch being connected between the first switch and the battery, to form the first current path.

The discharging of the battery may include turning off the first switch and turning on the second switch to form the second current path.

The method may further include converting a first voltage output from the battery into a second voltage, and providing the second voltage to a battery management system managing the battery.

The method may further include converting a voltage of a common grid into a third voltage, and providing the third voltage to the battery management system. The second voltage may be used as power for operating the battery management system when a power failure occurs in the common grid. The third voltage may be used as power for operating the battery management system when the common grid is operated normally.

### BRIEF DESCRIPTION OF THE DRAWINGS

Features will become apparent to those of skill in the art by describing in detail exemplary embodiments with reference to the attached drawings in which:

FIG. 1 illustrates a view of a power storage system according to an exemplary embodiment.

FIG. 2 illustrates a view of an inner constitution of a power storage device 160 according to the exemplary embodiment of FIG. 1.

FIG. 3 illustrates a view of a charging path during a charging operation of a battery rack.

FIG. 4 illustrates a view of a discharging path during a discharging operation of the battery rack.

FIG. 5 illustrates a view of an inner constitution of a power storage device according to another exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Now, a power storage system and a driving method thereof according to an exemplary embodiment will be described.

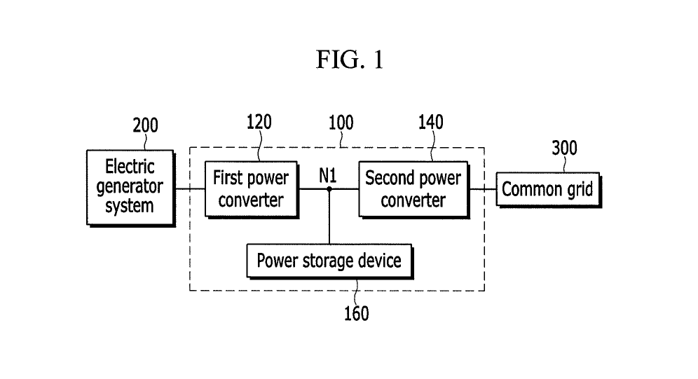

FIG. 1 illustrates a view of a power storage system according to an exemplary embodiment.

A power storage system 100 according to an exemplary embodiment is connected between an electric generator system 200 and a common grid 300.

The electric generator system 100 may include a system that generates electrical energy by using renewable energy such as sunlight, wind power, wave power, tidal power, or geothermal heat. The electric generator system 100 may include a common grid as well as the renewable energy.

The common grid 300 may include a power plant that generates power through firepower generation, waterpower generation, atomic energy generation, etc., and a substation and a transmission site to change a property of a voltage or a current to transmit the generated power to a sub-transmission circuit or a distribution line.

In FIG. 1, the power storage system 100 is shown as being connected to the common grid 300. It is to be understood that a load may be substituted for the common grid 300. The term “load” refers to various electrical devices that consume power, such as an electronic device of a home or a production device of a company.

As shown in FIG. 1, a power storage system 100 according to an exemplary embodiment includes a first power converter 120, a second power converter 140, and a power storage device 160.

The first power converter 120 is connected to an electric generator system 200 and converts first power generated in the electric generator system 200 into second power and transmits the second power to a node N1. The first power generated in the electric generator system 200 may be DC power or AC power. The power at the node N1 is DC power. The first power converter 120 may be a DC-DC converter that converts the first power of DC into DC power, or may be an AC-DC converter that converts the first power of AC into DC power.

The second power converter 140 is connected between the node N1 and the common grid 300. The second power converter 140 converts the DC power of the node N1 into the AC power and transmits it to the common grid 300. That is, the second power converter may be a DC-AC converter converting the DC power into the AC power.

The power storage device 160 is a device storing the DC power of the node N1. The power storage device 160 may resupply the stored power to the node N1 as the DC power during a power failure. During a power failure, the DC power supplied from the power storage device 160 to the node N1 is converted by the second power converter 140 and is transmitted to the common grid 300 or a load (not shown). Accordingly, during a power failure, stable power may be supplied to the common grid 300 or to the load.

The power storage device 160 may supply the DC power to the node N1 only during a power failure, or the power storage device 160 may constantly supply the stored power to the node N1. In the latter case, the power supplied in the electric generator system 200 would always be transmitted to the common grid 300 or the load through the power storage device 160.

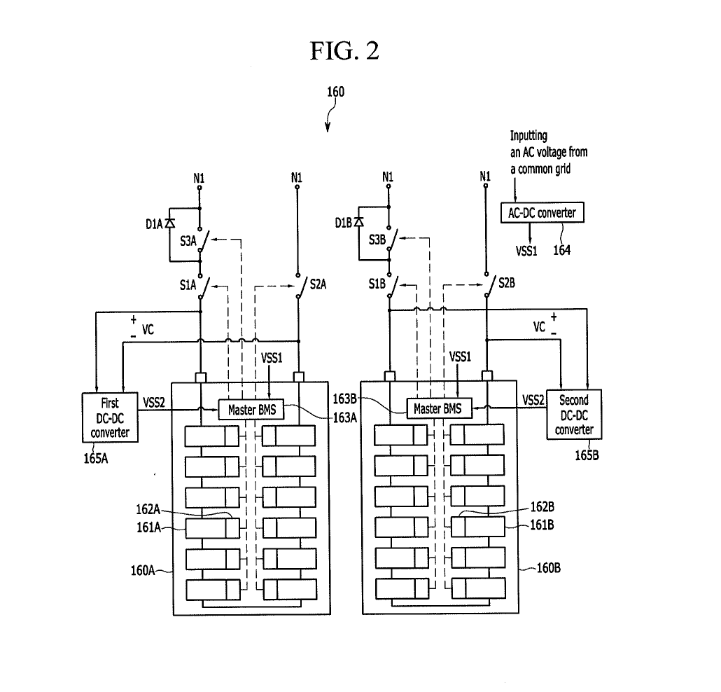

Referring to FIG. 2, the power storage device 160 according to the exemplary embodiment of FIG. 1 will be described in detail.

FIG. 2 illustrates a view of an inner constitution of the power storage device 160 according to this exemplary embodiment.

As shown in FIG. 2, the power storage device 160 according to the this exemplary embodiment includes a plurality of battery racks 160A and 160B, an AC-DC converter 164, a plurality of DC-DC converters 165A and 165B, a plurality of main switches S1A, S1B, S2A, and S2B, a plurality of charge switches S3A, S3B, and diodes D1A and D1B. In FIG. 2, flow of a voltage and a current is indicated by a solid line, and flow of a measuring signal and a switching control signal of a battery management system is indicated by a dotted line. In FIG. 2, the plurality of main switches S1A, S1B, S2A, and S2B and the plurality of charge switches S3A, S3B may be realized by a transistor performing a switching operation such as a FET having a body diode, a MOSFET, or a BJT.

The first battery rack 160A includes a plurality of battery packs 161A, a plurality of slave battery management systems 162A (referred to as a “slave BMS”) and a master battery management system 163A (referred to as a “master BMS”).

The plurality of battery packs 161A may be coupled in series to each other and may be connected to a positive potential output terminal (+) and a negative potential output terminal (−) of the battery rack 160A. The positive potential output terminal (+) and the negative potential output terminal (−) are respectively connected to a power line. The plurality of battery packs 161A may be coupled in series to output power through the positive potential output terminal (+) and the negative potential output terminal (−) to the power line. The battery pack 161A may include a plurality of cells that are coupled in parallel or in series. Each of the cells may be a rechargeable battery that can be repeatedly charged and discharged, such as, for example, a nickel-cadmium battery, a lead storage battery, a nickel metal hydride battery, a lithium ion battery, or a lithium polymer battery.

The plurality of slave BMSs 162A manages the charging and discharging of the battery pack 161A. The master BMS 163A manages the charge and discharge of all of the battery racks 160A. In FIG. 2, it is illustrated that a slave BMS 162A is provided for each battery pack 161A. However, in other implementations, the slave BMS 162A may be provided to manage the charge and discharge of a plurality of the battery packs 161A.

The slave BMS 162A measures a voltage, a current, and a temperature of each cell included in the battery pack 161A and transmits the measurements to the master BMS 163A. The master BMS 163A may calculate the state of charge (SOC) and state of health (SOH) of each cell or each battery pack 161A using the voltage, current, and temperature measurements transmitted from each slave BMS 162A, thereby controlling the charge and discharge of all battery racks 160A.

In another implementation, the slave BMS 162A may calculate the SOC and SOH of each cell by measuring the voltage, the current, and the temperature of each cell, and may transmit the SOC and SOH of each cell to the master BMS 163A along with the voltage, the current, and the temperature measurements of each cell. The master BMS 163A may control the charge and discharge of all battery racks 160A based on the SOC and SOH of each cell transmitted from the slave BMS 162A.

The master BMS 163A may detect whether faults have occurred with respect to the voltage and the current of each battery pack 161A or with respect to all battery racks 160A by evaluating the voltage, the current, and the temperature measurements transmitted from each slave BMS 162A. If a fault of any battery pack 161A or battery rack 160A is detected, the master BMS 163A may transmit a switching control signal to the main switches S1A and S2A to block the main switches S1A and S2A, thereby protecting the battery.

When a fault occurs in the master BMS 163A, any one among a plurality of slave BMSs 162A may perform the function of the master BMS 163A. The slave BMS 162A performing the function of the master BMS 163A may detect a fault with respect to the voltage and the current of the battery rack 160A and may transmit a switching control signal to the main switches S1A and S2A.

The master BMS 163A may generate a switching control signal to control the turn-on/turn-off of the charge switch S3A and may transmit the switching control signal to the charge switch S3A. When charging the battery rack 160A, the master BMS 163A according to an exemplary embodiment may turn on the charge and discharge switch S3A. When the charging operation is completed, the master BMS 163A may turn off the charge and discharge switch S3A.

As shown in FIG. 2, the second battery rack 160B may also include a plurality of battery packs 161B, a plurality of slave BMSs 162B, and a master BMS 163B, like the first battery rack 160A. The inner constitution and each constitution function of the second battery rack 160B may be the same as or similar to that of the first battery rack 160A. Accordingly, a detailed description thereof is not repeated.

The AC-DC converter 164 receives the AC voltage from the common grid 300, and converts the input AC voltage into the DC voltage Vss1 to be transmitted to the master BMS 163A and the master BMS 163B. The DC voltage Vss1 output from the AC-DC converter 164 may be used as operation power for operating the master BMS 163A and the master BMS 163B. Although not shown in FIG. 2, the DC voltage Vss1 may be transmitted to each slave BMS 162A and 162B to be used as the operation power for operating the slave BMSs 162A and 162B.

The first DC-DC converter 165A receives the charge voltage Vc output from the positive potential output terminal (+) and the negative potential output terminal (−) of the first battery rack 160A and converts the input charge voltage Vc into the DC voltage Vss2 to transmit the DC voltage Vss2 to the master BMS 163A. The DC voltage Vss2 generated in the first DC-DC converter 165A may also be used as the operation power for operating the master BMS 163A. The DC voltage Vss2 may be generated by using the charge voltage Vc of the first battery rack 160A such that the DC voltage Vss2 may be continuously supplied to the master BMS 163A even if the power of the common grid fails. Accordingly, during a power failure, the operation of the master BMS 163A may be possible such that the power storage device 160 may stably supply power to the common grid 300 or the load. The DC voltage Vss2 may also be transmitted to each slave BMS 162A to be used as the operation power for operating each slave BMS 162A.

The second DC-DC converter 165B receives the charge voltage Vc output from the positive potential output terminal (+) and the negative potential output terminal (−) of the second battery rack 160B, and converts the input charge voltage Vc into the DC voltage Vss2 to transmit the DC voltage Vss2 to the master BMS 163B. The DC voltage Vss2 generated in the second DC-DC converter 165B may be used as the operation power for operating the master BMS 163B. The DC voltage Vss2 may also be generated using the charge voltage Vc of the second battery rack 160B such that the DC voltage Vss2 may be continuously supplied to the master BMS 163B even if the power of the common grid fails. Accordingly, during a power failure, the operation of the master BMS 163B may be possible such that the power storage device 160 may stably supply power to the common grid 300 or the load. The DC voltage Vss2 may also be transmitted to each slave BMS 162B to be used as the operation power for operating each slave BMS 162B.

The first DC-DC converter 165A and the second DC-DC converter 165B may be operated generate the DC voltage Vss2 only in the case of a power failure. In other implementations, the first DC-DC converter 165A and the second DC-DC converter 165B may be continuously operated to generate the DC voltage Vss2 to be supplied to the master BMSs 163A and 163B regardless of whether there is a power failure.

One terminal of the main switch S1A is connected to the positive potential output terminal (+) of the first battery rack 160A. The other terminal of the main switch S1A is connected to the charge switch S3A. One terminal of the charge switch S3A is connected to the other terminal of the main switch S1A and the other terminal of the charge switch S3A is connected to the node N1. The anode of the diode D1A is connected to one terminal of the charge switch S3A and the cathode of the diode D1A is connected to the other terminal of the charge switch S3A. The main switch S2A is connected between the negative potential output terminal (−) of the first battery rack 160A and the node N1.

The main switches S1A and S2A maintain the turn-on state during charging/discharging to form a charging path and a discharging path. When a fault is generated in the first battery rack 160A, the main switches S1A and S2A are turned off to block the voltage and the current output from the positive potential output terminal (+) and the negative potential output terminal (−). The plurality of battery packs 161A are coupled in series such that the first battery rack 160A may output a high voltage of 1 kV and a high current and 300 A. Thereby, the main switch S1A and S2A may be realized as a semiconductor element for blocking the high voltage and the high current. The main switches S1A and S2A also form the charging path and the discharging path. Accordingly, the main switches S1A and S2A may be realized by a back-to-back switch in which a drain of one and a drain of the other are connected.

The charge switch S3A may be turned on for the charging operation of the first battery rack 160A to form the charging path and may be turned off when the charging is completed. The diode D1A may form the discharging path during the discharging operation of the first battery rack 160A. The charge switch S3A may be realized by an FET having a body diode. In the case of the charge switch S3A having the body diode, the discharging path may be formed through the body diode during the discharging operation. However in an exemplary embodiment, the discharging path may be formed through a separate diode D1A. The capacity of a body diode may be limited. Accordingly, in the exemplary embodiment, the discharging path may be formed through a separate diode D1A for the high voltage and the high current.

One terminal of the main switch S1B is connected to the positive potential output terminal (+) of the second battery rack 160B. The other terminal of the main switch S1B is connected to the charge switch S3B. One terminal of the charge switch S3B is connected to the other terminal of the main switch S1B and the other terminal of the charge switch S3B is connected to the node N1. The anode of the diode D1B is connected to one terminal of the charge switch S3B and the cathode of the diode D1B is connected to the other terminal of the charge switch S3B. The main switch S2B is connected between the negative potential output terminal (−) of the second battery rack 160B and the node N1.

The main switches S1B and S2B maintain the turn-on state during charging/discharging such that the charging path and discharging path are formed. When a fault is generated in the second battery rack 160B, the main switches S1B and S2B are turned off to block the voltage and the current output from the positive potential output terminal (+) and the negative potential output terminal (−). A high voltage and a high current may be output in the second battery rack 160B. Accordingly, the main switches S1B and S2B may be realized by a semiconductor element for preventing the high voltage and the high current. The main switches S1B and S2B also form the charging path and discharging path. Accordingly, the main switches S1B and S2B may be realized by a back-to-back switch in which a drain of one and the drain of the other are connected.

The charge switch S3B may be turned on during the charging operation of the second battery rack 160B to form the charging path and may be turned off when the charging is completed. The diode D1B may form the discharging path during the discharging operation of the second battery rack 160B. The charge switch S3B may be realized by an FET having a body diode. In the case of the charge switch S3B having the body diode, the discharging path may be formed through the body diode during the discharging operation. However in an exemplary embodiment, the discharging path may be formed through a separate diode D1B. The capacity of the body diode may be limited. Accordingly, in the exemplary embodiment, the discharging path may be formed through the separate diode D1B for the high voltage and the high current.

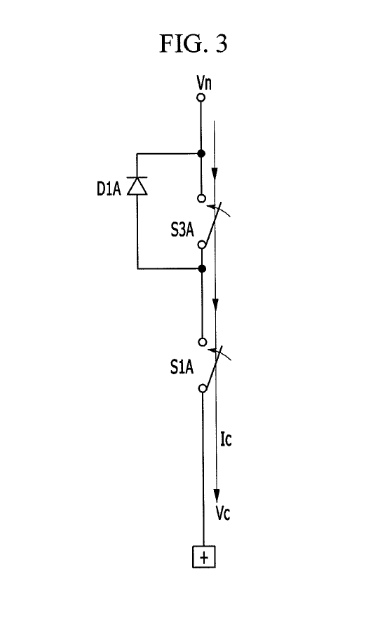

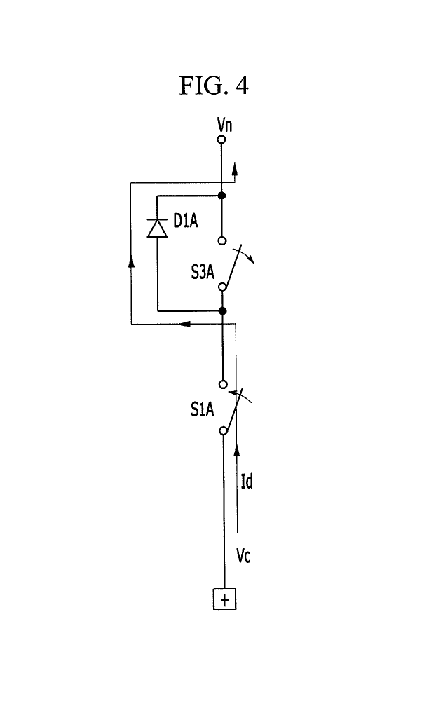

A charging and discharging operation of the power storage device 160 according to the exemplary embodiment will be described with reference to FIG. 3 and FIG. 4.

FIG. 3 illustrates a view of a charging path during a charging operation of the first battery rack 160A, and FIG. 4 illustrates a view of a discharging path during a discharging operation of the first battery rack 160A. In FIG. 3 and FIG. 4, Vn represents the voltage of the node N1, and Vc represents the charge voltage of the first battery rack 160A (i.e., the voltage of the positive potential output (+) of the first battery rack 160A).

The main switch S1A and the charge switch S3A are in a turned-on state during the charging operation of the first battery rack 160A. During the charging operation, the voltage Vn is a higher voltage than the charge voltage Vc. Accordingly, as shown in FIG. 3, the current path is formed into the node N1, the charge switch S3A, the main switch S1A, and the positive potential output (+) of the first battery rack 160A. Accordingly, the first battery rack 160A is charged with the charging current (Ic).

During the discharging operation of the first battery rack 160A, the main switch S1A is in a turned-on state and the charge switch S3A is in a turned-off state.

The discharging operation time may be a time in which the common grid 300 is in power failure state such that the voltage Vn is a lower voltage than the charge voltage Vc. As shown in FIG. 4, the current path may be formed with the positive potential output (+) of the first battery rack 160A, the main switch S1A, the diode D1A, and the node N1. Accordingly, the first battery rack 160A is discharged with the discharge current (Id).

Even if the charge switch S3A is not turned off but maintains the turned-on state during the discharging operation of the first battery rack 160A, the current path may be formed as shown in FIG. 4. During the discharging operation of the first battery rack 160A, the main switch S1A and the charge switch S3A may be turned on, as during the charging operation time. The charge switch S3A may be a unidirectional switch such that the discharging path is not formed through the charge switch S3A, but instead, is formed through the diode D1A. When the charge switch 3A is realized by a FET having a body diode, the discharging path could be formed through the body diode. However, as shown above, the body diode has a limited capacity such that in an exemplary embodiment, the discharging path is formed instead through the separate diode D1A. As described above, during the discharging operation, the voltage Vn is a lower voltage than the charge voltage Vc such that the current path as illustrated in FIG. 4 may be automatically formed due to the voltage difference.

As described above, according to this exemplary embodiment, instead of a separate switch forming the discharging path during the discharging operation, the current path is formed by the diode D1A. Accordingly, the power storage device 160 according to this exemplary embodiment may not only reduce the number of the switches, but also may avoid the use of a switch such that the switching loss may be reduced. In particular, a high current may flow during the discharging operation such that if an additional switch were to be used, an expensive switch would be required and the switching loss would be high. However, according to this exemplary embodiment, the number of expensive switches may be reduced and the switching loss may be reduced.

The charging and discharging operation of the second battery rack 160B may be the same as the charging and discharging operation of the first battery rack 160A. Accordingly, a detailed description thereof is not repeated.

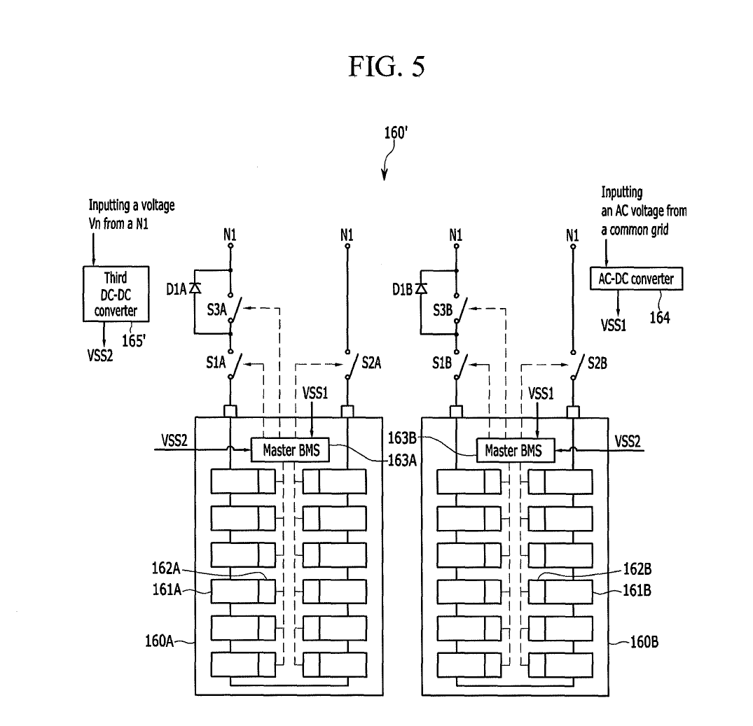

FIG. 5 illustrates a view of an inner constitution of a power storage device 160′ according to another exemplary embodiment.

As shown in FIG. 5, the power storage device 160′ according to this exemplary embodiment is the same as that according to the previous exemplary embodiment, except that a third DC-DC converter 165′ is used instead of the first and second DC-DC converters 165A and 165B.

The third DC-DC converter 165′ receives the voltage Vn of the DC voltage from the node N1 and converts the input voltage Vn into the DC voltage Vss2. The DC voltage Vss2 output from the third DC-DC converter 165′ is transmitted to the master BMS 163A and the master BMS 163B. The node N1 is a position where the power output from the first battery rack 160A and the second battery rack 160B are summed, and the third DC-DC converter 165′ generates the DC voltage Vss2 by using the voltage Vn of the node N1.

The DC voltage Vss2 generated by the third DC-DC converter 165′ is used as the operation power for operating the master BMS 163A and the master BMS 163B. The DC voltage Vss2 may be generated by using the output voltage of the first battery rack 160A and the second battery rack 160B. If a power failure occurs in the common grid, the DC voltage Vss2 may be continuously supplied to the master BMS 163A and master BMS 163B. Accordingly, if the power failure occurs in the common grid, the continued operation of the master BMS 163A and the master BMS 163B may be possible such that the power storage device 160 may stably supply the power to the common grid 300 or the load. The DC voltage Vss2 may be transmitted to each slave 165A and 165B and may also be used as the power for operating each slave 161A and 161B.

In FIG. 2 through FIG. 5, the first and second power storage devices are shown as including two battery racks 160A and 160B. However, other numbers of battery racks, such as one battery rack or three or more battery racks, may be included.

By way of summation and review, a device that stores generated power from a renewable energy source or from a common grid in a battery and stably supplies the stored power from the battery to a common grid (or to a load) when a power failure or an input problem occurs is referred to as an uninterruptible power supply system (hereafter referred to as a “UPS system”). The UPS system has been mainly used for computers, etc., to reduce damage such as a data loss or information loss. In the uninterruptible power supply system, a power storage system is a constituent element.

The power storage system may generally include a separate switch to be used when receiving input power and outputting stored power. However, switching loss may be generated during turn-on/turn-off of the switch. Such loss may be further generated when switching to higher power.

A power storage system may include a battery management system (hereafter referred to as “BMS”) to efficiently manage a charging and discharging operation of the battery. The battery management system is generally realized by a integrated circuit (IC), and an operation power source is generally used to operate the IC. Accordingly, if a common power source has failed, a continuous supply of operation power to normally operate the power storage system may be lacking.

In contrast, embodiments provide a power storage system that reduces a power loss, and a driving method thereof. In particular, the discharging path of the battery of the power storage system may be formed to pass through the diode instead of through a switch such that the number of switches may be reduced. A switching loss may be thereby reduced.

Embodiments also provide a power storage system that continuously supplies power even if a common power failure has occurred, and a driving method thereof. In particular, the operation power of the battery management system is provided by using the output of the battery of the power storage system. Accordingly, power may be continuously supplied even if a power failure occurs in the common grid.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A power storage system, comprising:
a battery that stores power;
a first switch connected between a first node and the battery, the first switch forming a path for charging the battery and including a body diode; and
a first diode connected between terminals of the first switch and forming a path for discharging the battery.

2. The power storage system as claimed in claim 1, further comprising a second switch connected between the first switch and the battery and forming a path for charging and discharging the battery.

3. The power storage system as claimed in claim 2, wherein:
when the battery is in a state of being charged, the first switch and the second switch are in a turned on state, and
when the battery is in a state of being discharged, the first switch is in a turned off state and the second switch is in the turned on state.

4. The power storage system as claimed in claim 2, wherein the second switch is in a turned-off state to protect the battery when a fault occurs in the battery.

5. The power storage system as claimed in claim 2, further comprising a battery management system that manages the battery, the battery management system controlling the first switch and the second switch.

6. The power storage system as claimed in claim 5, further comprising a DC-DC converter that converts a first voltage output from the battery into a second voltage, the second voltage being supplied as power for operating the battery management system.

7. The power storage system as claimed in claim 6, further comprising an AC-DC converter that converts a voltage of a common grid into a third voltage, the third voltage being supplied as power for operating the battery management system.

8. The power storage system as claimed in claim 7, wherein:
when a power failure occurs in the common grid, the second voltage is used as power for operating the battery management system, and
when the common grid is operated normally, the third voltage is used as power for operating the battery management system.

9. The power storage system as claimed in claim 5, wherein
the battery includes a first battery rack and a second battery rack respectively including a plurality of cells, and
the battery management system includes a first battery management system managing the first battery rack and a second battery management system managing the second battery rack.

10. The power storage system as claimed in claim 9, wherein:
a voltage output from the first battery rack and a voltage output from the second battery rack are output to the first node,
the power storage system further includes a DC-DC converter that converts a first voltage of the first node into a second voltage, and
the second voltage is used as power for operating the first battery management system and the second battery management system.

11. The power storage system as claimed in claim 1, further comprising:
a first power converter that converts a first power into a second power and provides the second power to the first node; and
a second power converter that converts the power of the first node into a third power and supplies the third power to a common grid or a load.

12. A method of driving a power storage system, the method comprising:
providing a battery storing power;
converting a first power into a second power and providing the second power to a first node;
charging the battery through a first current path by using the second power provided to the first node; and
discharging the battery through a second current path, the second current path including a diode connected between the battery and the first node.

13. The method as claimed in claim 12, wherein the charging of the battery includes turning on a first switch, the first switch being connected between the first node and the battery and including a body diode, to form the first current path.

14. The method as claimed in claim 13, wherein the charging of the battery includes turning on a second switch, the second switch being connected between the first switch and the battery, to form the first current path.

15. The method as claimed in claim 14, wherein
the discharging of the battery includes turning off the first switch and turning on the second switch to form the second current path.

16. The method as claimed in claim 12, further comprising:
converting a first voltage output from the battery into a second voltage; and
providing the second voltage to a battery management system managing the battery.

17. The method as claimed in claim 16, further comprising:
converting a voltage of a common grid into a third voltage; and
providing the third voltage to the battery management system,
wherein:
when a power failure occurs in the common grid, the second voltage is used as power for operating the battery management system, and
when the common grid is operated normally, the third voltage is used as power for operating the battery management system.
